(19) United States
(12) Patent Application Publication
(10) Pub. No.: US 2026/0099727 A1
(43) Pub. Date: Apr. 9, 2026

(54) LANGUAGE MODELS HAVING A REDUCED SIZE WHILE MAINTAINING PERFORMANCE AND REDUCING HALLUCINATIONS

(71) Applicant: Lenovo Global Technology (UnitedStates) Inc., Morrisville, NC (US)

(72) Inventors: Jeffrey Daniel Esposito, North Kingstown, RI (US); Henry Svendsgaard, Durham, NC (US); Aishwarya Dharani Arul, Dallas, TX (US); Tabor Scott, Waldorf, MD (US)

(21) Appl. No.: 19/041,065

(22) Filed: Jan. 30, 2025

Related U.S. Application Data
(60) Provisional application No. 63/703,786, filed on Oct. 4, 2024.

(51) Int. Cl. G06N 3/0985; G06N 3/09

(52) U.S. Cl. CPC G06N 3/0985; G06N 3/09

(57) ABSTRACT

A computer program product causes a processor to perform various operations. The operations include training a language model (LM) with a selected architecture using a training dataset focused on a specific content domain using pre-trained, supervised word embeddings and current values for a plurality of hyperparameters, such as a number of layers, hidden units, and/or parameters. The operations further include testing the trained LM on a validation dataset to obtain a performance of the trained LM, and, in response to the performance measurement being greater than the predetermined performance threshold, reducing the values of one or more of the hyperparameters and repeating the training. In addition, the operations include, in response to the performance not being greater than the threshold, selecting one of the previously trained LM that was trained using the smallest set of hyperparameter values and had a performance greater than the threshold and deploying the selected LM.

### BACKGROUND

The present disclosure relates to the design, training and use of language models.

### BACKGROUND OF THE RELATED ART

A Language Model (LM) is a statistical model used in Natural Language Processing (NLP) to understand and generate human language. A Large Language Model (LLM), such as OpenAI's GPT-3 or NVIDIA's NeMo framework, is a sophisticated and powerful version of a language model that is trained on vast amounts of text data to perform various language-related tasks. However, LLMs have some demonstrated drawbacks and limitations in the generative artificial intelligence space. These drawbacks include hallucinations, high training and computational costs, and data privacy concerns.

Language models may be used to leverage past experiences for customers. There are many use cases for such language models ranging from sales avatars that recall more than just what is in the shopping cart to chat bots that focus on technical set up and automation. However, while large language models are helpful in many use cases, they are not well-suited to address many other use cases.

### BRIEF SUMMARY

Some embodiments provide a computer program product comprising a non-transitory computer readable medium and program instructions embodied therein, the program instructions being configured to be executable by a processor to cause the processor to perform various operations. The operations comprise obtaining a training dataset focused on a specific content domain and a set of pre-trained, supervised word embeddings. The operations further comprise selecting a language model architecture, an initial set of values of a plurality of hyperparameters for a language model to be trained on the training dataset, and a predetermined performance threshold, wherein the plurality of hyperparameters include a number of layers, a number of hidden units, and/or an overall number of parameters. Still further, the operations comprise performing a set of operations including training the language model on the training dataset using the pre-trained, supervised word embeddings and current values for each of the hyperparameters, testing the trained language model on a validation dataset to obtain a performance measurement of the trained language model, and, in response to the performance measurement being greater than the predetermined performance threshold, reducing the values of one or more of the hyperparameters and repeating the set of operations. In addition, the operations comprise, in response to the performance measurement not being greater than the predetermined performance threshold, selecting the trained language model from a previous instance of the set of the operations that was trained using the smallest set of values of the hyperparameters and had a performance measurement greater than the predetermined threshold and deploying the selected language model. In one option, the smallest set of values of the hyperparameters includes the smallest number of parameters.

Some embodiments provide a computer program product comprising a non-transitory computer readable medium and program instructions embodied therein, the program instructions being configured to be executable by a processor to cause the processor to perform various operations. The operations comprise obtaining a collection of content within a specific content domain, identifying a plurality of specific topics within the specific content domain, and separating the collection of content into a plurality of content subgroups, wherein each content subgroup contains the content directed to one of the specific topics. The operations further comprise training, for each of the content subgroups, a separate language model on the content subgroup directed to the specific topic, providing a user interface for receiving a user prompt directed to the specific content domain, identifying one of the specific topics that is mostly closely related to subject matter of the user prompt, and directing the user prompt to one of the separate language models that is trained on the content subgroup directed to the specific topic. In reference to previous descriptions, the present operations describe the formation of a content hive including a plurality of trained language models that collectively cover the specific content domain.

### BRIEF DESCRIPTION OF THE SEVERAL VIEWS OF THE DRAWINGS

FIG. 1 is a diagram of a system in which one or more of the embodiments may be implemented.

FIG. 2 is a diagram of a search cascade according to one embodiment.

FIG. 3 is a diagram of a language model architecture according to one embodiment.

FIG. 4 is a diagram of a process for training a language model having a reduced size while maintaining a predetermined threshold level of performance according to one embodiment.

FIG. 5 is a diagram of a server according to some embodiments.

### DETAILED DESCRIPTION

Some embodiments provide a computer program product comprising a non-transitory computer readable medium and program instructions embodied therein, the program instructions being configured to be executable by a processor to cause the processor to perform various operations. The operations comprise obtaining a training dataset focused on a specific content domain and a set of pre-trained, supervised word embeddings. The operations further comprise selecting a language model architecture, an initial set of values of a plurality of hyperparameters for a language model to be trained on the training dataset, and a predetermined performance threshold, wherein the plurality of hyperparameters include a number of layers, a number of hidden units, and/or an overall number of parameters. Still further, the operations comprise performing a set of operations including training the language model on the training dataset using the pre-trained, supervised word embeddings and current values for each of the hyperparameters, testing the trained language model on a validation dataset to obtain a performance measurement of the trained language model, and, in response to the performance measurement being greater than the predetermined performance threshold, reducing the values of one or more of the hyperparameters and repeating the set of operations. In addition, the operations comprise, in response to the performance measurement not being greater than the predetermined performance threshold, selecting the trained language model from a previous instance of the set of the operations that was trained using the smallest set of values of the hyperparameters and had a performance measurement greater than the predetermined threshold and deploying the selected language model. In one option, the smallest set of values of the hyperparameters includes the smallest number of parameters.

A language model (LM) is a type of artificial intelligence (AI) model that processes human language and provides responses or answers to user prompts or questions in a way that mimics human communication. Embodiments of the language model may include any of a number of language model architectures, such as a recurrent neural network architecture or a basic transformer architecture. A language model having a selected language model architecture may be trained on a training data, which may include any of a number of types of training data such as curated, unsupervised and/or self-supervised. Word embeddings represent words as vectors of real numbers in a multidimensional space. The language model may use word embeddings, such as a set of pre-trained, supervised word embeddings, to look up the numerical representation of a word.

Hyperparameters for the language model are configuration variables that are used to affect the training of the language model. For example, model hyperparameters are settings that control the architecture and complexity of the language model, such as the number of layers in a neural network, and algorithm hyperparameters are settings that control the process of training the language model, such as a learning rate or batch size. Each of the hyperparameters that are relevant to the selected language model architecture may be assigned a value that is used during training. Hyperparameter tuning refers to a process involving a sequence of experiments in which the language model may be trained using different sets of hyperparameter values to identify a set of hyperparameter values that produce a desired result.

After selecting a language model architecture and a set of values of the hyperparameters, the language model may be trained using the training dataset and the word embeddings. During training, the language model adjusts the values of various parameters, such as the weights, within the model that influence the language model's operations. A loss function measures the difference between the model's predictions and the actual target values in a manner that guides adjustment of the values for these parameters during training to minimize the error and improve the model's accuracy. It should be understood that “hyperparameters” and “parameters” are distinctly different aspects of a language model.

A validation dataset is a subset of data that is used during the training process of an AI model to evaluate its performance and tune its hyperparameters. Unlike the training dataset, which the model learns from, the validation dataset provides an independent set of examples to test the model's ability to generalize to unseen data. It helps detect issues like overfitting, where the model performs well on the training data but poorly on new data. By measuring metrics such as accuracy, precision, recall, or loss on the validation set, developers can assess the model's performance and make adjustments to improve its robustness. The validation dataset plays a critical role in model selection, ensuring the chosen configuration balances complexity and predictive accuracy.

After training the language model, the trained language model may be tested using a validation dataset to obtain a performance measurement, such as accuracy or precision. As long as the performance measurement for the trained language model is greater than the predetermined performance threshold, the values of one or more of the hyperparameters may be reduced so that the language model is made smaller before repeating the set of operations, including the training operation. Accordingly, the language model is made smaller and smaller until the performance measurement is no longer greater than the predetermined performance threshold. In other words, the language model made smaller over a sequence of training iterations until the performance of the language model is negatively affected and not greater than the predetermined performance threshold. Preferably, once the size of the language model has been reduced to the point that it no longer performs above the predetermined performance threshold, the smallest trained language model from a previous training instance that still exhibited a performance measurement greater than the predetermined threshold is selected for deployment. Deploying the selected language model means taking the trained language model and making it accessible for real-world use by integrating it into a production environment. The deployed language model is allowed to receive new data and generate predictions in a live setting, essentially putting the model into action after it has been trained and tested. For example, deploying the language model may involve packaging the language model with necessary code or user interface and setting it up on a server to handle incoming requests for inference, such as a user prompt.

The size of the language model may be a function of various hyperparameters, such as the number of layers, the number of hidden units, and/or an overall number of parameters. Without limitation, one way to measure the size of a language model is by counting the number of parameters within the language model, which essentially refers to the adjustable values within the model's neural network that determine its learning capabilities. Training the language model on the training dataset using the reduced values of the one or more of the hyperparameters, such as a reduced number of layers or a reduced maximum number of parameters, causes the language model to have a smaller size than the language model trained on the training dataset using the initial set of values of the plurality of hyperparameters.

Some embodiments provide the technical benefit of providing a language model having a reduced or minimized size that was trained on a small training dataset of no more than a predetermined amount in order to reduce hallucinations and long training times. The term “hallucination” refers to the creation of false facts, sentences or prompt contradiction, and/or nonsensical, unrelated or off-point statements. In other words, a hallucination is output from a language model in which the information presented by the language model is incorrect because of the operation of the language model itself. By comparison, incorrect output from a language model is not a hallucination if the incorrect output was caused by training on incorrect information or by input of a prompt (input given during inferencing) with incorrect information.

Embodiments may utilize unsupervised data training but are not limited to using only unsupervised data training and may include training on labeled data. “Unsupervised data training” refers to the training of a language model using unlabeled data such that the model must learn patterns and relationships within the data without any explicit guidance or predefined categories. Labeled data is a collection of data that has been annotated with labels to help train the model. Furthermore, the language model may be trained using a form of self-supervised learning (SSL) in which the language model creates their own labels from unlabeled data. Accordingly, self-supervised learning is more closely related to unsupervised training than to supervised learning. For example, self-predictive learning (also known as auto associative self-supervised learning) trains a language model to predict part of an individual data sample based upon given information about its other parts. More particularly, a language model may implement self-predictive training using a sequence of data, where the language model examines the first N words in the sequence, and then attempts to predict the N+1 word and compare it with the actual N+1 word.

In some embodiments, the operations may further comprise generating and deploying the language model or one or more additional language models on-the-fly in response to receiving a user prompt regarding the specific content domain or similar trigger. It is a technical benefit of such embodiments to be able to generate and deploy a language model in real time as needed. Accordingly, a language model may be customized for a given situation or user prompt, trained on a real time training dataset, or trained on a private training dataset that is only available with user permission. For example, if a server customer/user initiates a helpdesk connection with the server manufacturer or systems integrator to troubleshoot an issue involving one of their servers or system management, a language model may be generated and deployed during the duration of the helpdesk connection using a training dataset that includes data that is specific to the customer's specific server environment, such as the type and number of servers, current firmware version(s), management controller settings, and the like. Accordingly, the response to the customer's prompt may be more responsive and specific to the customer's actual problem and may even suggest a specific resolution or offer to execute a command on the customer's behalf. In one non-limiting illustration, if the customer submitted a user prompt indicated that a certain feature was not operational of a server, a language model might be immediately trained on the customer's system server system architecture and/or current settings and subsequently generate a response (output) to the customer saying “I see your problem is that the server does not have this setting enabled, do you want me to enable it?”

In some embodiments, the operations may further comprise adding a content hive layer, automation layer, and/or creativity layer to the selected language model (having a reduced size while maintaining performance above a predetermined performance threshold), wherein the selected language model is deployed with the added content hive layer, automation layer, and/or creativity layer. For example, the language model may include multiple layers of attention mechanisms, feedforward networks, and normalization layers that work together to process and understand input sequences. However, embodiments may add one or more additional layers to expand the language model's response capability beyond simple understanding towards right action. Where the language model includes a content hive layer, automation layer, and/or creativity layer, those layers may be implemented in any order or even implemented in parallel.

In some embodiments, the operations may further comprise adding a content hive layer to the selected language model, wherein the content hive layer includes a plurality of content keys, and wherein each content key links to another language model. The content hive layer may include a plurality of context-specific hive content keys that enable chained responses within and across a plurality of language models within the content hive that collectively cover a specific content domain. For example, the content hive may include a plurality of language models, wherein each language model is trained on a subgroup of the collection of content forming the specific content domain. Each context-specific hive content key may map to one of the language models, where each language model may be labeled with an identifier or description of the specific topic or range of topics on which the language model was trained and is adapted to output a response. If a user prompt is initially directed to a first language model within the content hive, that first language model may send the user prompt and/or responsive output from the first language model to a second language model within the content hive for further inference processing. The

The term “content hive”, as used herein, refers to a collection of language models collectively focused on a specific content domain, wherein each language model within the content hive focuses on a subgroup of the content domain. By using a plurality of language models that collectively cover the specific content domain, each language model within the content hive may be smaller than a single language model trained to cover the entire content domain by itself. For example, the size of each language model may be limited, perhaps below a predetermined maximum size. In one option, if a subgroup of the specific content domain (i.e., either a measure of the training dataset or the resulting trained language model) exceeds the predetermined maximum size, then the subgroup of the content domain may be further subdivided into smaller content subgroups that each form a training dataset for a language model. Optionally, each language model within the content hive may be trained on a subgroup of the content domain that is curated to cover subject matter directed to a particular skill. It is a technical benefit that language models according to various embodiments that are kept small may be resistant to hallucinations and save on training time and expense. However, implementing a content hive may require a user interface or front-end module that receives the user prompt and determines which of the language models within the content should be used to handle the user prompt. Accordingly, the user interface or front-end module may direct the user prompt to a particular language model that is identified as being most-closely related to the subject matter of the user prompt.

In some embodiments, the operations may further comprise adding an automation or orchestration layer to the selected language model, wherein the automation or orchestration layer includes a plurality of automation aliases (also referred to as “keyed automation calls”), and wherein each automation alias maps output from a previous layer of the selected language model to an executable command. In one example, the specific content domain may be directed to server management protocols, wherein each executable command causes a change in a configuration management tool, package manager, infrastructure as code tool, or software build automation tool. It is a technical benefit that the language models may include the ability to identify and implement executable commands across vendors and automation or orchestration toolsets by way of simple, persisted reference. While both automation and orchestration involve using technology to perform tasks without human intervention, automation focuses on automating a single task, while orchestration manages and coordinates multiple automated tasks to execute a complex workflow or process. Orchestration is a more advanced level of automation that involves managing the sequence and dependencies between various automated steps and/or various entities.

In some embodiments, the operations may further comprise adding a creativity layer to the selected language model, wherein the creativity layer adjusts a creativity setting used by the selected language model to drive a level of performance of the selected language model. Creativity settings may set a range of language model operation from allowing explicit freedom or enforcing verbatim responses based on historical result contexts. Creativity settings may include temperature, top-p and top-k, which are considered hyperparameters that are used during the inference stage rather than the training phase of a language model. For example, the temperature setting regulates how much variation or randomness the language model introduces when generating outputs, with higher temperatures leading to more creative and diverse results, while lower temperatures produce more predictable and conservative outputs.

In some embodiments, the operations may further comprise establishing a sequential search cascade to address a user prompt. For example, the sequential search cascade may include a first level including a knowledge base, a second level including a content hive having a plurality of language models, a third level including a large language model (LLM), and a fourth level including a notification to a subject-matter expert. The user prompt received from a user may be submitted sequentially to the levels of the sequential search cascade until obtaining a response that matches the user prompt. A knowledge base is a centralized collection of information and resources that can be used to answer questions and solve problems. In one example, a knowledge may include a set of frequently asked questions (FAQ) that is made available to customers or other users. A description of a content hive has been described elsewhere herein. A large language model (LLM) is a type of artificial intelligence that has been trained on a massive dataset of text, allowing it to generate text, translate languages, answer questions, and perform various natural language processing tasks by understanding complex patterns and relationships within language. However, an LLM may lack specific knowledge or understanding of the specific content domain and/or specific user or customer data, may experience hallucinations, and requires extensive time and resources to train. A subject-matter expert, such as a server hardware or software engineer, may be the final resource for providing a response when the previous layers of the sequential search cascade were unable to produce a suitable or matching response to the user prompt. It is a technical benefit that the content hive may be implemented within the sequential search cascade between an ultra-specific knowledge base (where only authored question/answer pairs are provided) and a generic LLM (which might lack understanding of the customer data/environment). Furthermore, each language model in the content hive operates in the data layer of the Open System Interconnection (OSI) model.

The language models having a reduced size as described herein (i.e., “small” or “very tiny” language models trained on a subgroup of a specific content domain) may be referred to as an “extension’ beyond the use of Retrieval-Augmented Generation (RAG) in an LLM. RAG involves searching for context documents within a specific domain of information related to a user prompt and then providing those context documents to an LLM for use in generating a response to the user prompt. By contrast, the language models described herein are actually trained using context documents rather than simply using context documents during inference. Although the first step in responding to a user prompt may be to search for the best language model within the content hive to generate a response, the selected language model may be optimally training on the context documents within a subgroup of data from the specific content domain and may, therefore, have the ability to provide a more accurate response than an LLM or even a RAG model. The accuracy of a response to a user prompt is always a high priority but is critical when using the response to link to an executable command.

In some embodiments, the operations may further comprise adding a creativity layer to the selected language model, wherein the creativity layer adjusts a creativity setting used by the selected language model to drive a level of performance of the selected language model as a function of query complexity. For example, query complexity may be calculated as the sum of a length of the user prompt plus a number of levels in the search cascade required to obtain a response matching the user prompt, then dividing the sum by the elapsed search time from receiving the user prompt to obtaining the response. Other measures of query complexity may also be used to drive one or more creativity settings, such as temperature, top-p and/or top-k.

Some embodiments provide a computer program product comprising a non-transitory computer readable medium and program instructions embodied therein, the program instructions being configured to be executable by a processor to cause the processor to perform various operations. The operations comprise obtaining a collection of content within a specific content domain, identifying a plurality of specific topics within the specific content domain, and separating the collection of content into a plurality of content subgroups, wherein each content subgroup contains the content directed to one of the specific topics. The operations further comprise training, for each of the content subgroups, a separate language model on the content subgroup directed to the specific topic, providing a user interface for receiving a user prompt directed to the specific content domain, identifying one of the specific topics that is mostly closely related to subject matter of the user prompt, and directing the user prompt to one of the separate language models that is trained on the content subgroup directed to the specific topic. In reference to previous descriptions, the present operations describe the formation of a content hive including a plurality of trained language models that collectively cover the specific content domain.

In some embodiments, the operations may further comprise limiting each content subgroup to a predetermined maximum amount of content. For example, the predetermined maximum amount of content may be selected to limit the size of the resulting language model that will be trained on the content subgroup, such that the language model will be resistant to hallucinations and will be more efficient to train. In one option, the operation of limiting each content subgroup to a predetermined amount of content includes determining the amount of content in each content subgroup, identifying one of the content subgroups in which the amount of content exceeds the predetermined amount of content, and dividing the identified content subgroup into first and second content subgroups prior to training.

It is a technical benefit that a language model that has been trained on a content subgroup containing less that the predetermined amount of content may be characterized by an ability to provide a more accurate response to a user prompt than a large language model and a language model trained on the entire collection of content. Independently, it is a technical benefit that a language model that has been trained on a content subgroup containing less that the predetermined amount of content may be characterized by an ability to providing a response having fewer hallucinations than a large language model and a language model trained on the entire collection of content. Still further, it is a technical benefit that a language model that has been trained on a content subgroup containing less that the predetermined amount of content may be characterized by a shorter training time and/or expense than a large language model and a language model trained on the entire collection of content. Even further, it is a technical benefit that a language model that has been trained on a content subgroup containing less that the predetermined amount of content may be characterized by consuming fewer computing resources to run the language model than a large language model and a language model trained on the entire collection of content.

According to some embodiments, the cost of training the language models may be described as follows:

$$\begin{matrix}C = {C}_{0} \times N \times D \\ L = ( A / {N}^{α} ) + ( B / {D}^{β} ) + {L}_{0}\end{matrix}$$

where the variables are:
   C is the cost of training the model measured in Floating Point Operations (FLOPs);
   N is the number of parameters in the model;
   D is the number of tokens in the training dataset;
   L is the average negative log-likelihood loss per token (nats/token) achieved by the trained LM on the test dataset;
and the statistical hyper-parameters are:
   C₀=6, meaning that it costs 6 FLOPs per parameter to train on one token (Note that training cost is much higher than inference cost, where it costs 1 to 2 FLOPs per parameter to infer on one token);

$$\begin{matrix}α = 0.34 ; \\ β = 0.28 ; \\ A = 406.4 ; \\ B = 410.7 ; and \\ {L}_{0} = 1.69\end{matrix}$$

According to the equation for cost of training the model (C), it can be appreciated that the number of parameters in the model (N) (i.e., the “size” of the language model) and the number of tokens in the training dataset (D) (i.e., the amount of data in a training dataset) have a substantial impact on the cost of training.

In some embodiments, the operations may further comprise measuring the size of each language model after training, identifying one of the language models having a size that is greater than a predetermined maximum language model size, and replacing the identified language model with a first language model trained on a first portion of the content subgroup that was used to train the identified language model and a second language model trained on a second portion of the content subgroup that was used to train the identified language model. Accordingly, two language models may be used to replace a single language model with no effective change in the scope of content upon which the two language models are trained.

In some embodiments, the operation of training, for each of the content subgroups, the separate language model on the content subgroup directed to the specific topic may further comprise selecting a language model architecture for the language model, an initial set of values of a plurality of hyperparameters for the language model to be trained on one of the content subgroups, and a predetermined performance threshold for the language model, wherein the plurality of hyperparameters includes a number of layers, a number of hidden units, and/or an overall number of parameters. Subsequently, the operations may further comprise performing a set of operations including: training the language model on a different one of the content subgroups using the pre-trained, supervised word embeddings and current values for each of the hyperparameters, testing the trained language model on a validation dataset to obtain a performance measurement of the trained language model, and in response to the performance measurement being greater than the predetermined performance threshold, reducing the values of one or more of the hyperparameters and repeating the set of operations. In response to the performance measurement not being greater than the predetermined performance threshold, the operations may include selecting the trained language model from a previous instance of the set of the operations that was trained using the smallest set of values of the hyperparameters, such as the smallest number of parameters, and had a performance measurement greater than the predetermined threshold. Subsequently, the selected language model may be deployed.

In some embodiments, the specific content domain may include private data, wherein each of the language models increases the security of the private data by training on the private data within a secure environment so that the trained language model can respond to the user prompt without the user prompt or context data accompanying the user prompt containing the private data.

Some embodiments provide a computer program product comprising a non-transitory computer readable medium and program instructions embodied therein, the program instructions being configured to be executable by a processor to cause the processor to perform various operations. The operations comprise receiving a user prompt from a client computing device and submitting the user prompt to one or more levels of a search cascade in sequence until a matching response to the user prompt is obtained. The sequential search cascade comprises a first level including a knowledge base, a second level including a content hive having a plurality of language models, a third level including a large language model, and a fourth level including a notification to a subject-matter expert. The operations further comprise providing, in response to the first, second and/or third levels of the search cascade failing to obtain a matching response to the user prompt, the user prompt and any near matching information available from the first, second and/or third levels to the sequentially next level of the search cascade. Still further, the operations comprise sending the matching response obtained from any of the levels of the search cascade to the client computing device.

In some embodiments, the knowledge base and the content hive are limited to a collection of content within a specific content domain. For example, the knowledge base may include a plurality of predetermined questions and answers within the specific content domain, wherein each predetermined question is paired with a corresponding predetermined answer. Furthermore, each of the language models in the content hive may have been trained on a content subgroup from the collection of content, wherein the user prompt submitted to the content hive is directed to one of the language models that has been trained on the content subgroup that is most closely associated with the subject matter of the user prompt. In one option, the content hive may include an index identifying, for each of the language models in the content hive, the scope of subject matter in the content subgroup on which the language model has been trained. In another option, the operations may further comprise prompting a trainer to input an answer to the user prompt in response to none of the language models having a matching response to the user prompt, receiving the answer to the user prompt from the trainer, identifying the one of the language models that has been trained on a content subgroup that is most closely associated with the subject matter of the user prompt, and training a new language model to replace the identified language model, wherein the new language model is trained on the content subgroup from the collection of content and the answer input by the trainer.

In some embodiments, the operations may further comprise requesting additional information from the user about their user prompt in response to none of the VTLMs having a matching response to the user prompt. In addition, the operations may further comprise receiving the requested additional information from the user, supplementing the user prompt with the received additional information, and resubmitting the supplemented user prompt to the one or more levels of the search cascade in sequence until a matching response to the supplemented user prompt is obtained.

In some embodiments, the operations may further comprise storing (caching) recent user prompts and the matching responses obtained from the search cascade, searching for one of the stored recent user prompts that matches the received user prompt prior to submitting the user prompt to the first level of the search cascade, and sending, in response to identifying a recent user prompt that matches the received user prompt, a response to the user computing device containing the matching response to the recent user prompt that matches the received user prompt. For example, the recent user prompts and the matching responses obtained from the search cascade may be stored in cache memory or a searchable log file on a data storage device.

In some embodiments, the operations may further comprise sending a blended response to the client computing device in response to obtaining near matching responses from two or more levels of the search cascade, wherein the blended response includes content from the near matching response obtained from each of the two or more levels of the search cascade.

In some embodiments, the operations may further comprise sending a message including the near matching responses from two or more levels of the search cascade, wherein the near matching response are prioritized based on a query complexity score, wherein the query complexity score is calculated as the sum of a length of the user prompt plus a number of required levels in the search cascade to obtain a matching response, then dividing the sum by the elapsed search time from receiving the user prompt to sending the message.

In some embodiments, the operations may further comprise determining a performance measurement for one or more of the language models in the content hive and increasing a creativity setting for one or more of the language models in response to the performance measurement being less than a performance threshold.

In some embodiments, the operations may further comprise a first deployed language model receiving a user prompt, the first language model prompting a large language model to identify a user intent from the user prompt, the first language model identifying an executable command that implements the identified user intent, and the first language model executing the identified executable command. For example, the large language model may receive and analyze the user prompt and determine whether the user intent indicates a desire to receive information only or a desire for the first language model to take action by entering an executable command. In one option, an executable command that implements the identified user intent may be identified by accessing a plurality of records, each record mapping a user intent to an executable command. Furthermore, the operations may further comprise outputting a user notification indicating whether or not the executable command was executed successfully. Still further, the operations may further comprise providing the identified executable command in a user notification with a request for a user to authorize execution of the identified executable command and receiving a user response to the request in the user notification. Accordingly, the identified executable command may be executed only in response to a user response to the request indicating that the user authorizes execution of the identified executable command.

In some embodiments, the identified executable command may be various types of commands and may be executed in various manners. For example, an executable command such as a software installation may be executed in a manner that is dependent upon the target system, the desired level of abstraction, and the specific requirements of the task. In one example, the identified executable command may be executed by connecting with an application programming interface (API) to an automation or orchestration tool and entering the identified executable command into the application programming interface. In another example, the identified executable command may be executed by connecting with a command-line interface and entering the identified executable command into the command-line interface. In yet another example, the identified executable command may be executed by executing a shell script, configuration management tool, container, package manager or infrastructure as code. A shell script, such as a Bash Script, may be a concise script for software installations, leveraging package managers like ‘apt-get’ for Debian-based systems or ‘yum’ for Red Hat-based systems. Alternatively, a shell script may include an efficient and concisely crafted one-liner shell command using a tool like ‘curl’ or ‘wget’ to download and install software directly from the web. A shell script is a text file containing a sequence of commands that the shell (e.g., Bash, Zsh) interprets and executes. It allows you to automate repetitive tasks, combine multiple commands, and create powerful utilities.

Non-limiting examples of configuration management tools include Ansible, Chef and Puppet. Ansible enables defining efficient playbooks for software installations, allowing for idempotence (consistent state/result no matter how many times run) and concise descriptions of desired system states. Chef and Puppet are tools that enable the automation of software installation tasks, providing concise and declarative configurations. A non-limiting example of a containerization tool includes Docker or Dockerfiles, which provides efficient and concise instructions for building containers that encapsulate software dependencies, making deployment and distribution streamlined. Non-limiting examples of package managers include npm, pip, gem, etc. These are language-specific package managers for concise and efficient installation of libraries and dependencies in software development. Another package manager is Chocolatey (for Windows), which provides streamlined software installations on Windows systems with a concise command-line interface. Terraform is an Infrastructure as Code (IaC) tool, describing infrastructure and software dependencies in a concise, declarative manner, allowing for efficient provisioning and configuration. Make files or Make is a tool used in development environments to orchestrate and automate software build and installation processes concisely. Optionally, each executable command may be idempotent.

The term “idempotent” refers to the quality of producing no side-effects if repeated. For example, the language model may have some feedback or awareness of the outputs of its actions. So, if the language model outputs a first executable command to cause a computing system to “spin up 10 servers with IDs 1-10”, and then subsequently outputs a second executable command to cause the computing system to “spin up 10 servers with IDs 1-10”, the output of the second executable command will not cause the computing system to spin up another ten servers.

### Example Code for Calling Automation and Orchestration Tools

Creating a comprehensive system for initiating calls to orchestration and automation tools with Python code may involve integrating natural language processing (NLP) and connecting with the specific orchestration tool's API or command-line interface. The following is a simplified example for server provisioning via Ansible (a suite of command line tools or utilities) with a language model that is trained to server management protocols according to various embodiments herein. Adaptation and extension is assumed based on actual use case and tooling.

```
‘‘‘python
import requests
from transformers import pipeline
# Did this with the Hugging Face Transformers library
nlp_pipeline = pipeline(″text-classification″, model=″your-LLM-model″)
# Function to process user input and generate orchestration command
def generate_orchestration_command(user_input):
  # Use the LLM to recognize the intent from user input
  result = nlp_pipeline(user_input)
  intent = result[0][′label′]
  # Map recognized intents to corresponding orchestration commands
  command = map_intent_to_command(intent)
  return command
# Function to map intents to orchestration commands
def map_intent_to_command(intent):
  if intent == ′provision_server′:
    return ″ansible-playbook -i inventory.ini provision_server.yml″
  # Add more mappings based on your use case
# Function to execute the generated orchestration command
def execute_orchestration_command(command):
  # Use appropriate mechanism to execute the command, e.g., subprocess, API request, etc.
  response = requests.post(″your-orchestration-api-endpoint″, data={′command′: command})
  # Process the response or handle errors as needed
  if response.status_code == 200:
    print(″Orchestration command executed successfully″)
  else:
    print(f″Error executing orchestration command. Status code: {response.status_code}″)
# Example usage
user_input = ″Provision a new server with 4GB RAM″
orchestration_command = generate_orchestration_command(user_input)
execute_orchestration_command(orchestration_command)
‘‘‘
```

This example uses the Hugging Face Transformers library and a hypothetical mapping of user intents to executable orchestration commands. The placeholder values may be replaced with the actual language model, orchestration API endpoints, and specific command mappings. Specific integration details are expected to vary based on the specific orchestration tool to be used and its API or command-line interface. User input handling may be secured, especially if the language model is deployed in a hybrid cloud/internet via WA 2.0.

Embodiments of the language model are preferably formed using a small dataset. The hyperparameters, such as the maximum number of tokens and parameters, the number of hidden layers, the number of nodes/neurons per layer, learning rate and momentum, may differ based upon the use case, the complexity of a dataset of automation (executable command) responses (i.e., skill complexity), the amount of computing resources available to perform the language model and/or the number of language models in the content hive. Hyperparameter tuning or optimization may improve the performance of the language model for a given use case, preferably avoiding overfitting and keeping hallucination near zero. In one specific example, a language model was generated for orchestration or automation using an initial baseline of 12 layers until it was found that 20 layers was the optimal number of layers for a bash script. According to this example, additional language models for bash automation may be generated with 20 layers until performance of that language model automation type indicates that a different number of layers would be beneficial.

Embodiments of the language models, content hives and search cascades described herein may be applied to various applications. The disclosed features contribute to the adaptability and reliability of the embodiments, making the embodiments suitable for a wide range of applications in the field of artificial intelligence and natural language processing. Non-limiting examples of these applications may include natural language processing, content generation, information retrieval systems, and automated decision-making processes. Embodiments may optionally utilize Context Aligned Retrieval, Generation and Orchestration (CARGO) to create unique contextual personas with defined skills. For example, the language models may form the backend for online and hybrid services, such as a virtual sales assistant persona, a virtual site engineer persona (triage and phone home), and/or a virtual implementation engineer persona (standup and validation).

The foregoing computer program products may further include program instructions for implementing or initiating any one or more operations or aspects of methods described herein. Furthermore, the methods may further include any one or more operations or aspects of the computer program product described herein. Still further, embodiments may include systems that implement or initiate any one or more operations or aspects of the computer program products and/or methods described herein.

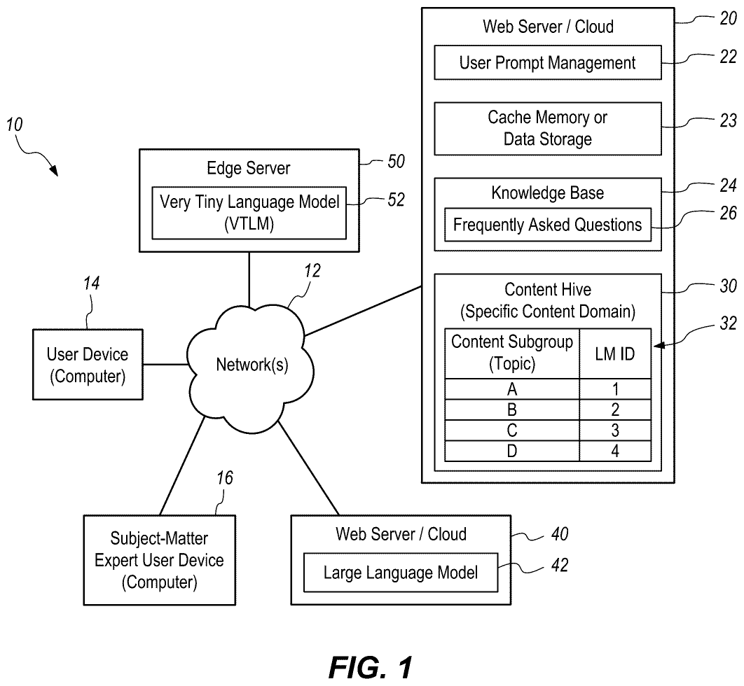

FIG. 1 is a diagram of a system 10 in which one or more of the embodiments may be implemented. The system 10 includes a plurality of entities that are connected via one or more networks 12. Accordingly, a user device 14 is able to access a web server or cloud computing environment 20 that runs a user prompt management software module 22, a knowledge base 24 includes a set of frequently asked questions (FAQs) 26, and a content hive 30 including a plurality of language models. Each of the language models has been trained on a content subgroup or topic (A-D) within a specific content domain and labeled with a language model identifier (1-4). Accordingly, a user of the user device (computer) 14 may submit a user prompt or question to the web server or cloud computing environment 20 over the network(s) 12 and receive a response back from the web server 20.

The user prompt management module 22 on the web server or cloud computing environment 20 may receive the user prompt and cause the user prompt to be processed by the knowledge base 24 and/or one or more language model within the content hive 30. In some embodiments, the user prompt management module 22 may implement a search cascade. For example, the user prompt management module 22 may initially submit the user prompt against the knowledge base 24, such as searching through the frequently asked questions 26 to see whether there is a question matching the user prompt. If the frequently asked questions 26 include a question matching the user prompt, then the answer corresponding to the question is provided to the user device 14 as a responsive output.

However, if the frequently asked questions 26 does not include a question matching the user prompt, then the user prompt may be directed to the content hive 30. Specifically, the user prompt management module 22 may compare the user prompt with the content subgroups (topics A-D) identified in a table or index 32 and direct the user prompt to the language model (LM ID 1-4) that is most relevant to the user prompt. If the selected language model is able to generate a response matching the user prompt, then that response is output to the user device 14. If the selected language model is not able to generate a response matching the user prompt, then the language model may use various content keys to transfer the user prompt to another one of the language models in the content hive 30.

In some embodiments, if the plurality of language models in the content hive 30 are unable to generate a response matching the user prompt, then the user prompt management module 22 may direct the user prompt to a large language model 42. The large language model 42 may be hosted on a separate web server or cloud computing environment 40 (as shown) but may alternatively be hosted on the same web server or cloud computing environment 20 with the knowledge base 24 and content hive 30.

In some embodiments, if the large language model 42 is unable to generate a response matching the user prompt, then the user prompt management module 22 may issue a call home command that initiates a notification to the designated device (computer) 16 of a subject matter expert.

In one option, the web server or cloud computing environment 20 may include a cache, such as cache memory or data storage 23. The cache 23 may store user prompts and corresponding matching responses that have been previously generated by any of the language models in the content hive 30, large language model 42 and/or subject-matter expert 16. Accordingly, use of the cache 23 may eliminate redundant or repetitive user prompts from consuming significant computing resources and provide latency in providing a response to the user prompt. When a cache is available and active, the user prompt management 22 may search the cache 23 as part of the search cascade. Preferably, the user prompt management 22 will search the cache 23 for a response to a user prompt before submitting the user prompt to the knowledge base 24, content hive 30, large language model 42, and/or subject-matter expert 16.

Separate from the use of a search cascade, a very tiny language model (VTLM) or other type of artificial intelligence (AI) model 52 may be implemented on a separate server, such as an edge server 50. The AI model 52 implements various embodiments to achieve a small size while maintaining a predetermined level of performance. The small size of the AI model 52 enables the model to be hosted on the edge server 50 which may have modest computing resources that would be unable to run a large language model.

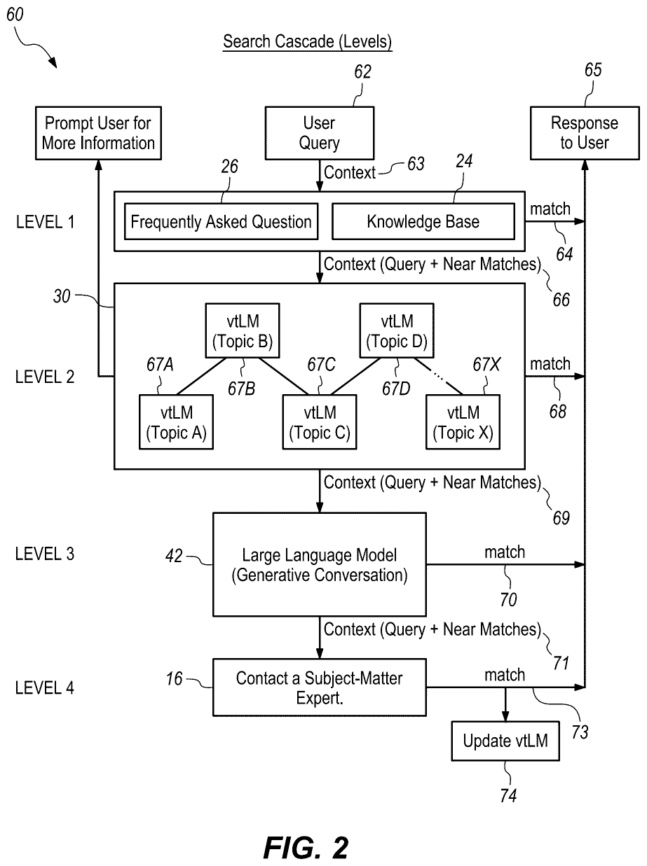

FIG. 2 is a diagram of a search cascade 60 including four levels (LEVEL 1-4) according to one embodiment. The user prompt 62 is received from a user device and provides a first context 63 for searching a knowledge base 24 and/or a set of frequently asked questions (FAQs) 26 in LEVEL 1. If LEVEL 1 is found to contain a match for the first context 63, then the matching output 64 is provided as a response to the user 65. Whether the response is a “match”, “near match” or “no match” to a user prompt/query may be determined through the particular hive index instance in question, which is the quantized value of the content stored down to the individual VTLM.

If LEVEL 1 is not found to contain a match for the first context 63, then a second context 66 is provided to LEVEL 2 through interlayer communication, wherein the second context 66 includes the first context 63 plus any near matching responses from LEVEL 1. LEVEL 2 provides a content hive including a plurality of language models, such as very tiny language models (VTLMs) 67A through 67X. Each of the very tiny language models are trained to respond to user prompts within a specific topic (Topics A through X) within a specific content domain. If one of the very tiny language models (VTLMs) 67A through 67X generates a response matching the second context 66, then the matching output 68 is provided as a response to the user 65. Whether the response is a “match”, “near match” or “no match” to a user prompt/query may be determined using various similarity metrics, such as cosine similarity, word overlap or embedding-based methods. For example, the similarity metrics may compare a generated response to an expected response based on some portion of the training data or validation data. A matching response, near matching response, or not matching response may each be associated with a range of values of the selected similarity metric.

If LEVEL 2 is not found to contain a match for the second context 66, then a third context 69 is provided to LEVEL 3, wherein the third context 69 includes the first context 63 plus any near matching responses from LEVEL 1 and/or LEVEL 2. LEVEL 3 includes a large language model (LLM) 42. If the large language models (LLM) 42 generates a response matching the third context 69, then the matching output 70 is provided as a response to the user 65.

If LEVEL 3 does not result in a response matching the third context 69, then a fourth context 71 is provided to LEVEL 4, wherein the fourth context 71 includes the first context 63 plus any near matching responses from LEVEL 1, LEVEL 2 and/or LEVEL 3. LEVEL 4 contacts a subject-matter expert 16, such as a call home to a system engineer. If the subject-matter expert 16 generates a suitable response to the user prompt or query 62, the matching output 73 is provided as a response to the user 65. In addition, the content of the response generated by the subject-matter expert 16 may be used to update (see “Update VTLM” operation 74) one of the very tiny language models (VTLMs) 67A through 67X. For example, updating a VTLM may involve adding the response to the training dataset and training a replacement VTLM on the training dataset with the additional content. Optionally, a VTLM and/or the LLM may be updated to include frequent matches as “ranked responses”. Furthermore, where no match is found, the user may be prompted to enter a correct answer to their own user prompt following troubleshooting and determined a correct response or successful resolution of the question or issue. Ultimately, the answer entered by the user may be used to update the VTLM.

While the illustrated embodiment provides a matching response directly to the user when a match is found, embodiments may also provide a blended response to the user based on the aggregated responses when no match is found. Accordingly, near matches may be collected or aggregated from one or more levels of the search cascade to form a comprehensive output when no match is found throughout the search cascade. For example, the comprehensive output may blend or prioritize near matching responses based on a Query Complexity score when no match is found. One query complexity score may be calculated as the sum of a length of the user prompt plus a number of required levels in the search cascade to obtain a matching response, then dividing the sum by the elapsed search time from receiving the user prompt to sending the message.

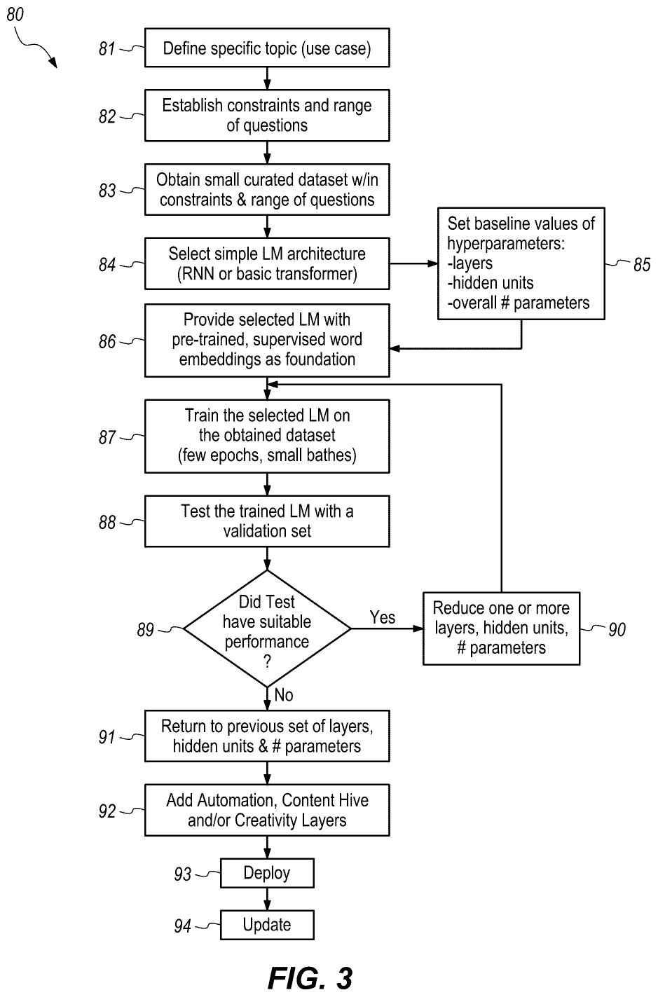

FIG. 3 is a diagram of a process 80 for training a language model to have a reduced size and at least a predetermined threshold level of performance according to one embodiment. In particular, the process 80 illustrates a manner to make the language model “as tiny as possible” while maintaining the predetermined threshold level of performance.

Operation 81 includes defining a specific topic or use case for the language model. For example, the specific topic may be a subset of a specific content domain. The specific content domain and the specific topics within the content domain should be clearly defined and limited in scope. Operation 82 includes establishing constraints and a range of questions to be addressed by the language model. Operation 83 includes obtaining a small, curated training dataset within the constraints and range of questions. The training dataset should be limited to the specific topic and should be sufficiently diverse to cover different aspects of the specific topic. The training dataset is preferably cleaned to remove any unnecessary information and keep the training dataset concise to match the specific topic and an approved range of prompts/questions.

Operation 84 includes selecting a simple language model architecture, such as a small recurrent neural network (RNN) or a basic transformer with a small number of layers and parameters. The language model architecture may be selected in light of the task to be performed, such as in consideration of whether or not automation (executable commands), content-hive (multiple language models) or creativity are required. Operation 85 includes setting baseline values of various hyperparameters, such as a number of layers, number of hidden units, and/or an overall number of parameters. Operation 86 includes providing the selected language model with pre-trained, supervised word embeddings.

Operations 87 through 90 establish a loop of operations that reduce the size of the trained language model while maintaining a suitable performance. Operation 87 includes training the selected language model on the training dataset, perhaps using a small number of epochs (i.e., the number of complete passes through the entire training dataset) and a small batch size (i.e., the number of training samples that are processed by the model before updating or normalizing its parameters). Operation 88 includes testing the language model using a validation dataset to determine a performance of the language model and Operation 89 includes determining whether the performance of the model was suitable, such as whether the performance was greater than a predetermined performance threshold. If the performance was suitable, then the process branches to Operation 90 which includes reducing one or more of the hyperparameters, such as the number of layers, number of hidden units, and/or an overall number of parameters, then returning to Operation 87. However, if the performance was not found suitable in Operation 87, then the process branches to Operation 91.

Operation 91 includes returning to a language model trained on the previous set of hyperparameters (i.e., numbers of layers, hidden units and/or parameters) that exhibited a suitable performance (i.e., greater than the predetermined performance threshold). While the most recently trained version of the language model was found to have unsuitable performance, presumably because the model had become too small, the previous trained version of the language model that was found to have suitable performance and has a size that was reduced. The model's size may be kept very small by limiting the number of layers, the number of hidden units (i.e., neurons within a hidden layer), and/or the overall number of parameters.

Operation 92 includes adding an automation layer, content hive layer and/or creativity layer to the language model. Operation 93 includes deploying the language model and Operation 94 includes updating the language model as additional data becomes available. For example, the language model may be refined over time, such as in response to an update in the core data within the specific content domain and/or an update in the automation responses that are available.

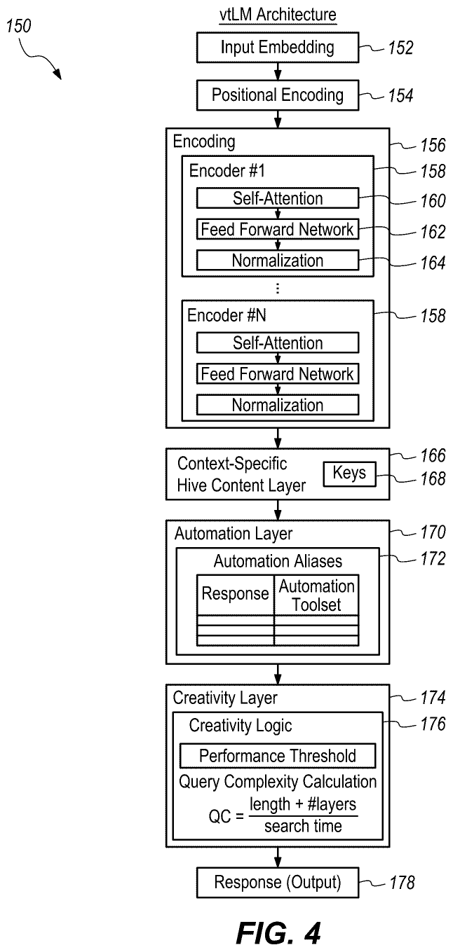

FIG. 4 is a diagram of a language model architecture 150, such as a very tiny language model (VTLM), according to one embodiment. The language model architecture 150 includes input embedding 152, positional encoding 154, and a plurality of encoding layers 156. In this non-limiting example, each individual encoding layer or encoder (1-N) 158 within the encoding layers 156 may include a self-attention layer 160, a feed forward network 162, and a normalization layer 164. Within the encoding layers 156, each individual encoding layer or encoder 158 processes through its self-attention layer 160, feed forward network 162, and normalization layer 164 before the subsequent encoding layer or encoder 158.

The language model architecture 150 may further include a context-specific hive content layer 166 including keys or labels 168 to each of the other language models within the same content hive, an automation layer 170 include a set of automation aliases 172 that map a response to an executable command or automation toolset, and/or a creativity layer 174 including a performance threshold and a query complexity algorithm for driving creativity. After processing input, such as a user prompt, through the layers of the language model architecture 150, a response 178 is output.

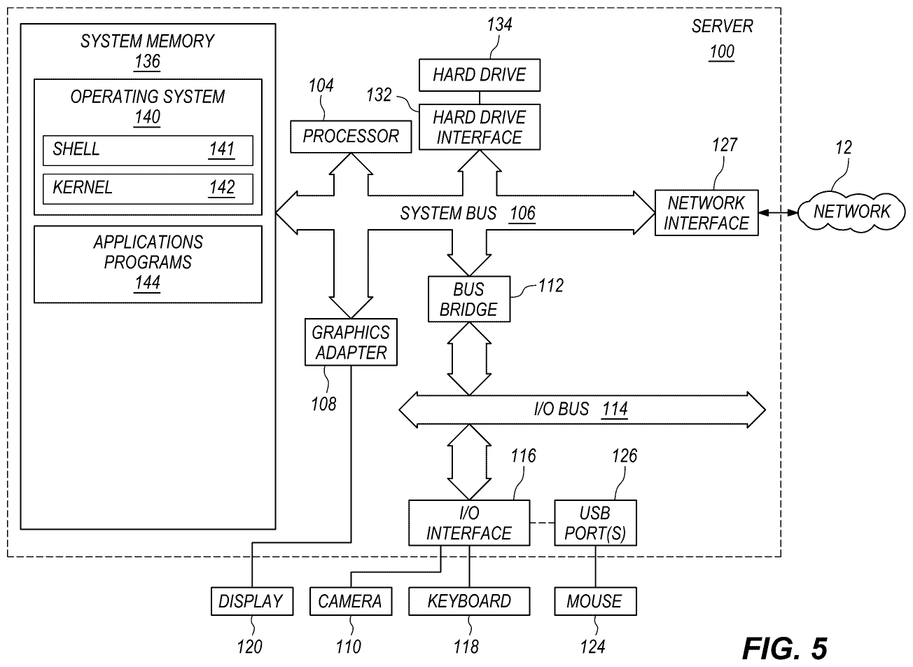

FIG. 5 is a diagram of a computer or server 100 according to some embodiments. The server 100 may be representative of a web server or computer in the cloud environment 20 (see FIG. 1) that runs the cache, knowledge base and/or content hive of language models, a web server or computer in the cloud environment 40 (see FIG. 1) that runs the large language model 42, an edge server 50 that runs an individual language model 52, a user device 14, and/or a subject-matter expert user device 16.

The server 100 includes a processor unit 104 that is coupled to a system bus 106. The processor unit 104 may utilize one or more processors, each of which has one or more processor cores. An optional graphics adapter 108, which may or may not drive/support an optional display 120, is also coupled to system bus 106. The graphics adapter 108 may, for example, include a graphics processing unit (GPU). The system bus 106 may be coupled via a bus bridge 112 to an input/output (I/O) bus 114. An I/O interface 116 is coupled to the I/O bus 114, where the I/O interface 116 affords a connection with various optional I/O devices, such as a camera 110, a keyboard 118 (such as a touch screen virtual keyboard), and a USB mouse 124 via USB port(s) 126 (or other type of pointing device, such as a trackpad). As depicted, the computer 100 is able to communicate with other network devices over network(s) 12 using a network adapter or network interface controller 127.

A hard drive interface 132 is also coupled to the system bus 106. The hard drive interface 132 interfaces with a hard drive 134. In a preferred embodiment, the hard drive 134 may communicate with system memory 136, which is also coupled to the system bus 106. The system memory may be volatile or non-volatile and may include additional higher levels of volatile memory (not shown), including, but not limited to, cache memory, registers and buffers. Data that populates the system memory 136 may include the operating system (OS) 140 and application programs 144. The hardware elements depicted in the server 100 are not intended to be exhaustive but rather are representative.

The operating system 114 includes a shell 141 for providing transparent user access to resources such as application programs 144. Generally, the shell 141 is a program that provides an interpreter and an interface between the user and the operating system. More specifically, the shell 141 may execute commands that are entered into a command line user interface or from a file. Thus, the shell 141, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 141 may be a text-based, line-oriented user interface, the present invention may support other user interface modes, such as graphical, voice, gestural, etc.

As depicted, the operating system 140 also includes the kernel 142, which includes lower levels of functionality for the operating system 140, including providing essential services required by other parts of the operating system 140 and application programs 144. Such essential services may include memory management, process and task management, disk management, and mouse and keyboard management. In addition, the computer server 100 may include application programs 144 stored in the system memory 136. In one example where the server 100 represents the web server or cloud environment 20 of FIG. 1, the application programs 144 may include the user prompt management software module 22 and the plurality of language models in the content hive 30.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-transitory computer readable medium and program instructions embodied therein, the program instructions being configured to be executable by a processor to cause the processor to perform operations comprising:
obtaining a training dataset focused on a specific content domain and a set of pre-trained, supervised word embeddings;
selecting a language model architecture, an initial set of values of a plurality of hyperparameters for a language model to be trained on the training dataset, and a predetermined performance threshold, wherein the plurality of hyperparameters includes a number of layers, a number of hidden units, and/or an overall number of parameters;
performing a set of operations including:
training the language model on the training dataset using the pre-trained, supervised word embeddings and current values for each of the hyperparameters;
testing the trained language model on a validation dataset to obtain a performance measurement of the trained language model; and
in response to the performance measurement being greater than the predetermined performance threshold, reducing the values of one or more of the hyperparameters and repeating the set of operations;
in response to the performance measurement not being greater than the predetermined performance threshold, selecting the trained language model from a previous instance of the set of the operations that was trained using the smallest set of values of the hyperparameters and had a performance measurement greater than the predetermined threshold; and
deploying the selected language model.

2. The computer program product of claim 1, wherein training the language model on the training dataset using the reduced values of the one or more of the hyperparameters causes the language model to have a smaller size than the language model trained on the training dataset using the initial set of values of the plurality of hyperparameters.

3. The computer program product of claim 1, wherein the language model has a recurrent neural network architecture or a basic transformer architecture.

4. The computer program product of claim 1, wherein the training dataset is curated.

5. The computer program product of claim 1, wherein the training dataset is unsupervised or self-supervised.

6. The computer program product of claim 1, the operations further comprising:
generating and deploying the language model on-the-fly in response to receiving a user prompt regarding the specific content domain; and
causing the language model that was generated and deployed on-the-fly to generate a response to the user prompt.

7. The computer program product of claim 6, wherein the training dataset includes data that is specific to a user submitting the query.

8. The computer program product of claim 7, wherein the data that is specific to the user submitting the query includes data describing a computing system associated with the user.

9. The computer program product of claim 1, the operations further comprising:
adding a content hive layer to the selected language model, wherein the content hive layer includes a plurality of content keys, wherein each content key links to another language model.

10. The computer program product of claim 1, the operations further comprising:
adding an automation layer to the selected language model, wherein the automation layer includes a plurality of automation aliases, wherein each automation alias maps output from a previous layer of the selected language model to an executable command.

11. The computer program product of claim 10, wherein the specific content domain is directed to server management protocols, and wherein each executable command causes a change in a configuration management tool, package manager, infrastructure as code tool, or software build automation tool.

12. The computer program product of claim 1, the operations further comprising:
adding a creativity layer to the selected language model, wherein the creativity layer adjusts a creativity setting used by the selected language model to drive a level of performance of the selected language model.

13. The computer program product of claim 1, the operations further comprising:
establishing a sequential search cascade to address a user prompt submitted to the deployed language model, wherein the sequential search cascade comprises a first level including a knowledge base, a second level including a content hive having a plurality of language models, a third level including a LLM, and a fourth level including a notification to a subject-matter expert, wherein the user prompt is submitted sequentially to the levels of the sequential search cascade until obtaining a response matching the user prompt.

14. The computer program product of claim 13, the operations further comprising:
adding a creativity layer to the selected language model, wherein the creativity layer adjusts a creativity setting used by the selected language model to drive a level of performance of the selected language model as a function of query complexity, wherein the query complexity is calculated as the sum of a length of the user prompt plus a number of levels in the search cascade required to obtain a response matching the user prompt, then dividing the sum by the elapsed search time from receiving the user prompt to obtaining the response.

15. A computer program product comprising a non-transitory computer readable medium and program instructions embodied therein, the program instructions being configured to be executable by a processor to cause the processor to perform operations comprising:
obtaining a collection of content within a specific content domain;
identifying a plurality of specific topics within the specific content domain;
separating the collection of content into a plurality of content subgroups, wherein each content subgroup contains the content directed to one of the specific topics;
training, for each of the content subgroups, a separate language model on the content subgroup directed to the specific topic; and
providing a user interface for receiving a user prompt directed to the specific content domain, identifying one of the specific topics that is mostly closely related to subject matter of the user prompt, and directing the user prompt to one of the separate language models that is trained on the content subgroup directed to the specific topic.

16. The computer program product of claim 15, the operations further comprising:
limiting each content subgroup to a predetermined maximum amount of content.

17. The computer program product of claim 16, wherein limiting each content subgroup to a predetermined amount of content includes:
determining the amount of content in each content subgroup;
identifying one of the content subgroups in which the amount of content exceeds the predetermined amount of content; and
dividing the identified content subgroup into first and second content subgroups prior to training.

18. The computer program product of claim 15, the operations further comprising:
measuring the size of each language model after training;
identifying one of the language models having a size that is greater than a predetermined maximum language model size;
replacing the identified language model with a first language model trained on a first portion of the content subgroup that was used to train the identified language model and a second language model trained on a second portion of the content subgroup that was used to train the identified language model.

19. The computer program product of claim 15, wherein training, for each of the content subgroups, the separate language model on the content subgroup directed to the specific topic further comprises:
selecting a language model architecture for the language model, an initial set of values of a plurality of hyperparameters for the language model to be trained on one of the content subgroups, and a predetermined performance threshold for the language model, wherein the plurality of hyperparameters includes a number of layers, a number of hidden units, and/or an overall number of parameters;
performing a set of operations including:
training the language model on a different one of the content subgroups using the pre-trained, supervised word embeddings and current values for each of the hyperparameters;
testing the trained language model on a validation dataset to obtain a performance measurement of the trained language model; and
in response to the performance measurement being greater than the predetermined performance threshold, reducing the values of one or more of the hyperparameters and repeating the set of operations;
in response to the performance measurement not being greater than the predetermined performance threshold, selecting the trained language model from a previous instance of the set of the operations that was trained using the smallest set of values of the hyperparameters and had a performance measurement greater than the predetermined threshold; and
deploying the selected language model.

20. The computer program product of claim 15, the operations further comprising:
a first one of the separate language models redirecting the user prompt to a second one of the separate language models if the user prompt is not within the scope of the first one of the separate language models.
